(19) United States
(12) Patent Application Publication
(10) Pub. No.: US 2003/0209517 A1
(43) Pub. Date: Nov. 13, 2003

(54) Post oxidation mass finishing techniques for prosthetic devices having textured diffusion-hardened surfaces

(76) Inventors: Brian McGehee, Southaven, MS (US); Les Darby, Batesville, MS (US)

Correspondence Address: Joel R Petrow Esq, Smith & Nephew, 1450 Brooks Road, Memphis, TN, 38116, US

(21) Appl. No.: 10/140,917

(22) Filed: May 8, 2002

(51) Int. Cl. C23F 1/00; B05D 1/32; B05D 5/00; B05D 3/00

(52) U.S. Cl. 216/41; 216/44; 216/45; 216/49; 216/51; 216/52; 427/282; 134/2

(57) ABSTRACT

A maskant plate is described which allows for protection of textured, diffusion-hardened surfaces on prosthetic devices while not interfering with common post-oxidation mass finishing procedures which are often used to form the finished product after surface oxidation.

### BACKGROUND OF THE INVENTION

Oxidized zirconium surfaces have been demonstrated to possess a number of advantages over conventional ceramic and metal surfaces, when used in prosthetic devices. The surfaces demonstrate low friction and high wear resistance similar to the properties of conventional ceramics. However, they also possess high strength and high thermal conductivity similar to the properties of conventional metal surfaces. While these surfaces were known in the prior art to be useful in other fields, they were first applied to prosthetic devices in pioneering work by Davidson in U.S. Pat. No. 5,037,438.

U.S. Pat. No. 2,987,352 to Watson first disclosed a method of producing zirconium bearings with a specific form of oxidized zirconium as a surface layer. The method of Watson was refined by Haygarth (U.S. Pat. No. 4,671,824) resulting in improved abrasion resistance and better dimensional control of the oxidized product. The U.S. Patents of Davidson (U.S. Pat. Nos. 5,037,438; 5,152,794; 5,180,394; 5,370,694; 5,372,660; 5,496,359; and 5,549,667) demonstrated the many advantages that are realized through the use of the specific form of oxidized zirconium on zirconium and zirconium alloy substrates in prosthetic devices. These include increased strength, low friction and high wear resistance. U.S. Pat. No. 5,037,438 to Davidson first disclosed a method of producing zirconium alloy prostheses with an oxidized zirconium surface. The work of Watson and Davidson teach a specific form of oxidized zirconium which possesses all of the advantages of ceramic materials while maintaining the strength of metallic surfaces. The oxide layer is characterized by the presence of free oxygen which diffuses into the interior of the material, near the metallic substrate. The resulting “diffusion hardened” surfaces have oxide layers that possess properties that combine the unique advantages of both ceramic and metal surface, while simultaneously minimizing the disadvantages of these materials. All of the U.S. Patents cited above to Davidson, Watson, and Haygarth are incorporated by reference as though fully set forth herein. While the early work of Davidson focused on pure zirconium and alloys of zirconium in which zirconium was the predominant metal, later work has shown that this is not necessary in order to form the desired diffusion hardened oxide. For instance, an alloy of 74 wt % titanium, 13 wt % niobium and 13 wt % zirconium (“Ti-13-13”) will form the diffusion hardened oxidation layer used herein. Ti-13-13 is taught in U.S. Pat. No. 5,169,597, which is incorporated by reference as though fully set forth herein.

Another important performance criterion for medical implants is the degree of fixation stability. This is typically accomplished through ingrowth of surrounding tissue into the implant and its ability to become firmly anchored to other components such as bone cement with a large shear strength. A typical hip joint prosthesis includes a stem fixated into the femur, a femoral head, and an acetabular cup against which the femoral head articulates. A typical knee joint prosthesis has a femoral and tibial component, both of which is fixated to the respective bones. This is the stability to which the implant is anchored in place. This fixation could be to either bone or other tissue, or it could be to other material, such as bone cement, etc. The fixation stability of the prostheses of Davidson was realized in their use of porous metal beads or wire mesh coatings the promoted bone in-growth and increased surface area for adhesion to other materials. These techniques are taught in U.S. Pat. No. 5,037,438 and other patents of Davidson, and when combined with the advantages of oxidized zirconium, represented an improvement in performance of medical implants in numerous areas. Nevertheless, continued improvement in the fixation stability of such implants is desirable.

Excessive play in the device relative to the tissue or bone often leads to premature failure of the device and the need for early and multiple revisions. This problem becomes particularly acute when the recipient is young and active. For this reason, a number of approaches have been used to improve fixation of medical implants. While early methodology involved the use of bone cements and other fixation media, it is preferable to promote bone ingrowth into the prosthetic device, thereby promoting joinder of the bone and device. Roughened surfaces on prosthetic devices are often used to promote such in-growth. The mode of action of such surfaces involves the enhanced ability of the bone to anchor itself onto the surface of the prosthetic device, owing to the increased surface area of the latter.

Another mechanism is believed to be at work as well. Textured (i.e., roughened surfaces) tend to be abrasive to the bone surface against which they articulate. The roughened surface thereby makes inroads into the bone and ingrowth is promoted. It has been found that this latter mechanism is particularly prominent with very hard surfaces on the prosthetic device. A roughened and hard surface will exhibit a greater tendency to abrade the bone against which it articulates. As a result, the contribution of this mechanism to the overall fixation stability is enhanced in such cases. This is particularly true in the case of textured surfaces of diffusion-hardened materials. The most notable of these is textured oxidized zirconium.

It is generally understood that surface roughening results in increased surface area which typically leads to better adhesion for the fixation of two surfaces. Although a smooth surface minimizes the stresses within the implant, it also minimizes the total surface area. This decreased surface area significantly reduces the strength of the attachment of the implant to the bone and tissue, which is largely dependent upon the mechanical interaction of the implant and the tissue. This mechanical interaction is of two forms. One is a form of interlocking to the extent the tissue grows behind or around a part of the implant. The other is frictional, wherein the tissue grows into intimate approximation with the surface and results in a relatively tight frictional fit.

Wagner et al. have demonstrated a method in U.S. Pat. No. 5,922,029 (and the resulting product in U.S. Pat. No. 6,193,762) using an electrochemical etching techniques to create attachment surfaces having random irregular patterns that promote bone tissue ingrowth and also to facilitate joining of the surface to a second material. Wagner et al. teach analogous methods (U.S. Pat. No. 5,258,098) and medical implant products (U.S. Pat. No. 5,507,815) in which the etching methodology used is purely chemical. Although the techniques of Wagner et al. represent one potential source of methods for surface texture modification it is expected that any other surface texture modification techniques would be similarly useful in aiding fixation. For example, the teachings of Frey (U.S. Pat. No. 4,272,855), Van Kampen (U.S. Pat. No. 4,673,409, Sump (U.S. Pat. No. 4,644,942), and Noiles (U.S. Pat. No. 4,865,603), among others, can be combined with in situ diffusion hardened surface oxidation of Davidson to produce a prosthesis surface having the superior attributes of surface oxidation as well as the stabilization and in-growth enhancement benefits accruing from macroscopic texture modification. The aforementioned patents of Wagner, Frey, Van Kampen, and Noiles are incorporated by reference as though fully set forth herein. The unique combination of in situ diffusion hardened surface oxidation with the texturing of surfaces is described in co-pending application 60/338,420 which is incorporated by reference as though fully set forth herein.

Upon formation, diffusion hardened surfaces require post-oxidation mass finishing techniques to provide devices suitable for medical implants. The high temperature conditions necessary to form a diffusion-hardened oxidized surface result in relatively severe dimensional changes in comparison to the untreated substrate material. Mass finishing techniques are designed to address these changes and to address other issues to effect a device suitable for implantation. However, these post-oxidation mass finishing techniques may potentially modify the textured surface such that its ability to promote fixation stability is diminished. Thus, one must protect the textured surface, while completing mass finishing on the remainder of the prosthetic device. An ideal maskant will completely protect the masked portion, while having no effect on the performance of the mass finishing procedures elsewhere on the prosthetic device.

The use of maskants has been applied to the fabrication of electronic devices. See, e.g., U.S. Pat. Nos. 5,271,953 and 5,240,746 to Litteral. However, these applications involve the use of curable viscous maskants and are not well suited to the mass-finishing of medical implants due to their tendency to flake-off and the difficulty in completely removing them upon completion of the operation. This is true of chemical maskants in general, some examples of which in the prior art are U.S. Pat. No. 5,126,005 to Blake, U.S. Pat. No. 5,066,450 to Steinicke, and U.S. Pat. No. 4,325,779 to Rossetti. Babayan (U.S. Pat. No. 3,948,829) describes a thin coating for masking metal surfaces. However, the maskants of Babayan are polymeric compositions perform poorly in the case of mass finishing of medical implants. They have a tendency to detach from the surface and contaminate the mass finishing media, thereby altering the properties of the media. In U.S. Pat. No. 4,612,737 to Adee a method and resulting product produced by attaching a maskant prepared to have a perforation pattern and useful for grit-blasting is desired. However, the primary goal in the use of the maskant of Adee is to assist in the formation of a final pattern on the surface, rather than the complete protection of a selected surface of the material. Additionally, consideration of weight and geometry (aside from the perforation pattern) of the maskant are not addressed or optimized. Examples of maskant materials of Adee include polyurethane or vinyl.

Thus, there exists the need for a method to protect selected portions of texture modified diffusion hardened surfaces of prosthetic devices such that mass finishing techniques affect only targeted portions of the overall device, and the mass finishing procedure is not adversely affected. The method must not be subject to the shortcomings of the prior art. In the present disclosure we teach methodology which is particularly useful to that end.

### SUMMARY OF THE INVENTION

The present invention comprises a method of masking a textured diffusion-hardened surface on a prosthetic device during post-oxidation mass finishing having the steps of positioning a plate on at least a part of the textured surface, performing post-oxidation a mass finishing procedure and, removing the plate. In a specific embodiment, the plate may be a sheet metal plate. In the preferred embodiment, the plate is a stainless steel plate. In an alternative embodiment, the plate may be a plastic plate. In one example of the plastic plate embodiment, the plate is a polyvinyl chloride plate.

In a specific embodiment, the method further comprising repeating one or more times, the steps of positioning, performing, and removing.

The textured diffusion-hardened surface may comprise a number of different compositions. In some examples of specific embodiments, it comprises a composition selected from the group consisting of oxidized zirconium, oxidized hafnium, oxidized niobium, and oxidized titanium. In the preferred embodiment, the textured diffusion-hardened surface comprises oxidized zirconium. In some examples of specific embodiments, the textured diffusion-hardened surface is formed on a substrate comprising materials selected from the group consisting of zirconium, titanium, hafnium, niobium, and alloys thereof. In the preferred embodiment, the textured diffusion-hardened surface is formed on a substrate comprising zirconium or zirconium alloy.

In a specific embodiment, the method the substrate consists of an alloy composition of from about 10 to about 50 weight % niobium, from about 13 to about 20 weight % zirconium with the balance being titanium. In an alternative embodiment, the substrate consists of an alloy composition of about 74 weight % titanium, about 13 weight % niobium, about 13 weight % zirconium.

In a specific embodiment of the method of the present invention, the positioning further step comprises positioning with a mandrel. Alternatively, the positioning step comprises positioning using a locking ring or set screw or both.

In a specific embodiment, the step of positioning comprises positioning a plate which completely covers and extends past the textured surface to be masked. In the preferred embodiment, the step of positioning a plate comprises completely covering and extending past the textured surface by about 10% of the total length of the textured region.

The post-oxidation mass finishing step may comprise any number of suitable mass finishing steps. In the preferred embodiment, the step of performing post oxidation mass finishing comprises a tumbling procedure. Alternatively, the step of performing post oxidation mass finishing comprises a grit-blasting procedure. In another alternative embodiment, the post oxidation mass finishing comprises a cleaning procedure. In yet another alternative embodiment, the post oxidation mass finishing comprises the application of laser light to the prosthetic device. In a specific embodiment involving application of laser light, the application of laser light further comprises laser marking of the prosthetic device. In another alternative embodiment, the step of performing post oxidation mass finishing comprises a passivation step. In a specific embodiment involving a passivation step, the passivation step further comprises contacting the prosthetic device with a nitric acid solution.

### DETAILED DESCRIPTION OF THE DRAWINGS

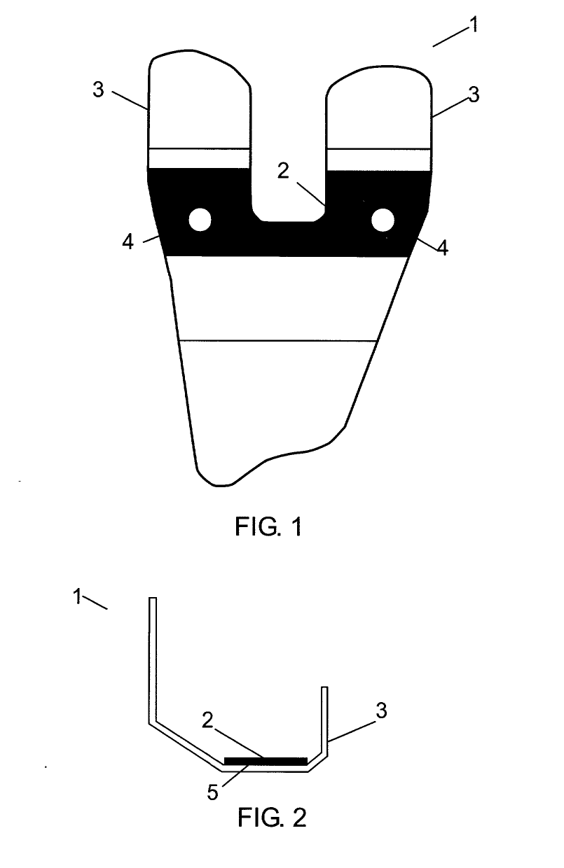

FIG. 1. Typical maskant device for a knee prosthesis without a locking collar.

FIG. 2. Side view of maskant device on a knee prosthesis without a locking collar.

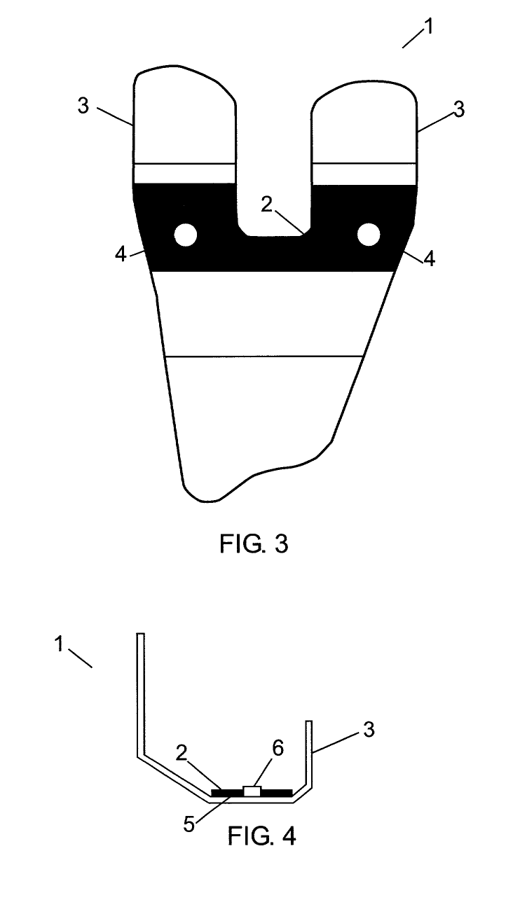

FIG. 3. Typical maskant device for a knee prosthesis having a locking collar.

FIG. 4. Side view of maskant device on a knee prosthesis having a locking collar.

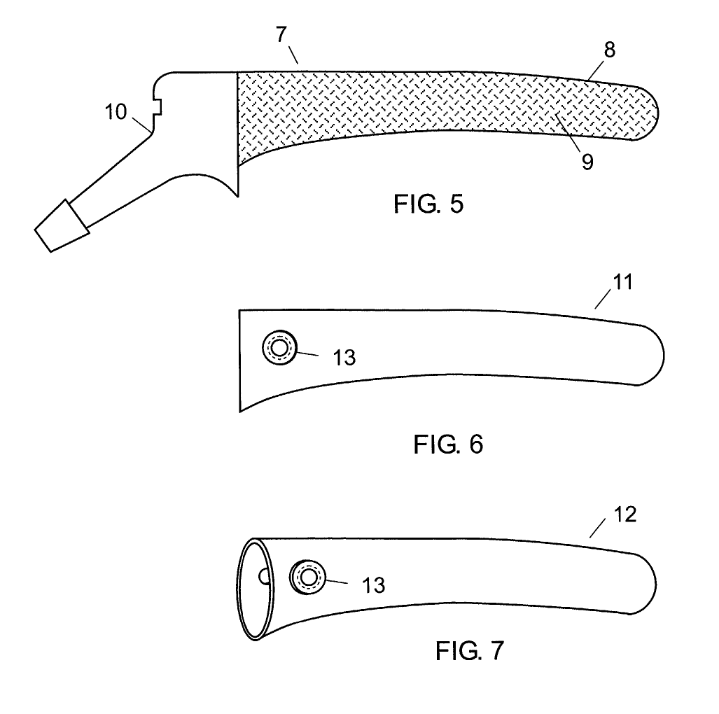

FIG. 5. Femoral component of typical hip prosthesis.

FIG. 6. Head-on view of broad side of stainless steel protective plate for a textured hip stem.

FIG. 7. Offset view of stainless steel protective plate for a textured hip stem showing opening to plate interior.

### DETAILED DESCRIPTION OF THE INVENTION

As used herein in the specification, “a” or “an” means one or more. As used herein in the claims, when used in conjunction with the word “comprising”, the words “a” or “an” may mean one or more than one. As used herein, “another” may mean at least a second or more.

As used herein, “alloy” is defined as any solution of two or more metallic elements.

As used herein, “metal” encompasses a pure, homogenous substance of one element, or an alloy of more than one element. As used herein, “metallic” is defined as of or pertaining to pure, homogenous substances of one element, or an alloy of more than one element.

As used herein, “substrate” is defined as the underlying bulk material from which a surface composition is formed.

Due to the high temperatures required in the formation of diffusion-hardened oxidized surfaces, dimensional changes, as well as other changes are likely to occur during the surface layer formation process. As a result, one or more post-oxidation mass finishing techniques are often required to address these changes. In the present invention, the inventors address the problem of protecting selected surfaces of the prosthetic devices from the mass finishing techniques while allowing other surfaces to be exposed. The description below will focus on knee prostheses, however, one of ordinary skill in the art will readily appreciate the applicability to any prosthetic device employing diffusion-hardened, textured surfaces.

One surface for which the present invention finds applicability is that of oxidized zirconium. This surface is formed via an in-situ oxidation process in which oxygen diffuses into the zirconium substrate forming the oxidized surface. The resulting diffusion-hardened surface possesses the advantages of both metals and ceramics. The U.S. Patents of Davidson (U.S. Pat. Nos. 5,037,438; 5,152,794; 5,180,394; 5,370,694; 5,372,660; 5,496,359; and 5,549,667) describe this surface and are incorporated by reference as though filly described herein. Diffusion hardened surfaces formed from substrates of titanium, hafnium, niobium can be used with the method of the present invention. The resulting diffusion-hardened surfaces in each case would be comprised of oxidized forms of the aforementioned metals. One particular embodiment of a substrate, which when oxidized by diffusion-hardening is applicable to the present invention, is the composition having from about 10 to about 50 weight % niobium; from about 13 to about 20 weight % zirconium; and, the balance titanium. Another example of a substrate, which when oxidized by diffusion-hardening is applicable to the present invention is one having about 74 weight % titanium, about 13 weight % niobium, and about 13 weight % zirconium. These “Ti-13-13”-based substrates are described in U.S. Pat. No. 5,169,597, which is incorporated by reference as though fully described herein.

The inventors have found that to withstand the stress of typical post-oxidation mass finishing procedures while simultaneously providing protection to the textured surface, the maskant material must exhibit good durability and corrosion-resistance, and preferably be relatively easy to manufacture. With respect to durability, the maskant must withstand the mass finishing procedure without detaching from the surface to be protected, but ideally it should also be capable of withstanding numerous cycles during its useful life. It must also possess a geometric design that is adequate to protect at least a part of the textured surface. With respect to this latter point, it is notable that most post-oxidation mass finishing procedures are particularly aggressive on the more pronounced protruding features of the device treated. Edges in general and the boundaries between textured and non-textured portions of the device are particularly susceptible to the action of these procedures. Finally, it is desirable that the maskant piece be easily attachable and detachable from the prosthetic device before and after the mass finishing procedures. In this way, the number of necessary cleaning steps minimized, avoiding unnecessary contact with the textured surface and thereby minimizing the likelihood that the desired characteristics of the surface are compromised.

FIGS. 1-4 schematically depict a typical masking device (2) on a knee prosthesis (1), illustrating top and side views. FIGS. 1 and 3 illustrate the top view (from the femor), while FIGS. 2 and 4 illustrate the side view. The figures illustrate the condyles (3) and the femoral posts (4), illustrated in top view only; while the shaded areas illustrate the maskant plate (2). In the top views, it can be seen that this particular mask plate is machined to completely cover the entire femoral face (5). The textured surface (not shown) may comprise some or all of the femoral face. The side views (bottom figure in each case) provides an alternative view for each figure. From the side view of FIG. 2, it can be observed that no collars or posts are included in this masking device. The device of FIGS. 1 and 2 would be applicable in post-oxidation mass finishing operations in which the prosthetic device is secured to the maskant through other means, for example, through the use of a mandrel. FIGS. 3 and 4 schematically depicts another such device, similar in all aspects with the notable exception that it possesses a set collar (6) illustrated on the side view of FIG. 4 on the femoral face (5) of the knee. The mask plate is then fabricated to accommodate the set collar. This set collar is used to secure the mask plate in operations such as those requiring “free tumbling, wherein the prosthetic device tumbles freely in a drum while in contact with the post-oxidation mass finishing media. In this case, the locking collar is used to insure that the maskant remains in place during the mass finishing operation. Other examples, particularly those involving other prostheses such as hips, shoulders, etc., would be clear to one of ordinary skill in the art upon a reading of the present disclosure.

FIG. 5 illustrates the femoral component of a typical hip prosthesis. FIGS. 6 and 7 depict an embodiment of the present invention useful in protecting textured surfaces on hip prostheses. The femoral component (7) of a hip prosthesis is anchored into the femor. Fixation stability is typically realized by in-growth and on-growth onto the surface of the hip stem (8). Maintenance of the integrity of the textured surface (9) in this area is critical to good fixation stability. FIG. 5 demonstrates the femoral component (7) of a hip prosthesis showing the area (10) requiring mass finishing and the area (9) having a textured surface requiring protection during mass finishing operations. The protective plate is shown in a head-on view of the broad side (11) of the device in FIG. 6 and offset view (12) in FIG. 7; the latter view demonstrates the sheath-like nature of this device. A threaded boss (13) on each side of the device is used in conjunction with two non-marring set screws (not shown) to affix the device to the hip stem (8) during mass finishing operations.

Weight and bulk considerations are important for the maskant piece. Typical mass finishing procedures involve tumbling in various media or blasting with mass finishing media while simultaneously controlling the movement (usually rotation about some axis) of the prosthetic device. Oftentimes, this involves the use of mandrels to hold the device while it is being exposed to the mass finishing media. Alternatively, locking rings and/or set screws may be used in conjunction with the various posts present on the prosthetic device. An asymmetric center of gravity tends to result in mass finishing results which are non-uniform due to overexposure of one or more particular surface regions of the device relative to other surface regions. It is preferable for the protective device to be relatively thin such that it clings closely to the prosthetic device and does not result in an excessive increase in bulk of the protected device relative to the unprotected device. If the protective device skews the weight distribution or center of gravity of the workpiece or otherwise adds unnecessary bulk to it, the subsequent mass finishing step may be non-uniform; i.e., certain areas of the workpiece may experience more of the mass finishing media than other areas. One skilled in the art recognizes that a uniform mass finish is desired.

Those having skill in the art would recognize that a wide range of materials are suitable for the fabrication of the protective plates of the present invention, provided that they possess the aforementioned favorable weight characteristics and resistance to the particular mass-finishing medium. These may be natural or synthetic products, such as metal or plastics, etc. Upon experimenting with a number of different maskant materials, the inventors have found that thin (typically ⅛^{th} of an inch or less) plates are optimal maskant materials for such applications. Preferably, a sheet metal plate is used. Most preferably, a stainless steel plate is used. In the preferred embodiment for an artificial knee, the plate is machined to possess holes for the condyler posts. The maskant plate is then placed through the holes and onto the textured surface, after which the posts are attached to the mandrel. If the mass finishing procedure does not make use of a mandrel, then suitable locking rings, set screws, or other equivalent devices may then be used to secure the maskant material to the prosthetic device. In most cases, it is desirable for the maskant material, whatever its composition may be, to completely cover and extend past the boundary where the textured surface ends in order to protect the edges and boundaries and further to prevent mass finishing media to reach the interstitial region between the maskant material and the textured surface to any appreciable extent. Preferably, the maskant material should extend past the boundary or edge by about 10% of the total length of the textured region, if possible.

While thin metal plates are preferred because they possess the proper weight and chemical/mechanical resistance to the most common mass finishing media, other materials are also within the scope of the present invention. Many plastics are useful in this regard. A particular plastic which possesses the required durability, corrosion-resistance, and weight properties is polyvinyl chloride, although other such plastics possessing these same strength and weight characteristics are known to those of ordinary skill in the art.

However, a common problem with plates fabricated from lightweight materials such as plastic is that to achieve the desired durability to withstand exposure to the mass finishing media under typical mass finishing conditions, the plate must be so thick as to create a mass imbalance in the masked device. As discussed above, this leads to unfavorable (i.e., non-uniform) results in mass finishing wherein exposure to the mass finishing procedure is more pronounced in some unmasked areas relative to other unmasked areas. These materials may be useful in some cases, but are less than ideal. Rubbery materials or paint-based coatings typically suffer from the disadvantage of becoming easily detached from the textured surface during mass finishing and contaminating the media, thereby oftentimes reducing its effectiveness or otherwise altering its results. Moreover, the dough-like nature of such maskants results in the some of the material adhering to the recessions in the textured surface. Nevertheless, rubbery materials or paint-based coatings which do not possess these negative attributes may be useful in the present invention. A person having ordinary skill in the art would quickly recognize those materials which are useful in the present invention through minimal testing.

The maskant plates herein described are useful to protect textured surfaces (and perhaps other surfaces in which protection is desired) for a number of different post-oxidation mass finishing procedures. In all cases, the maskant plate is attached before mass finishing and simply removed afterwards. The invention herein is applicable to a wide variety of such procedures. For example, the plates are particularly useful in mass finishing procedures in which the prosthetic device is tumbled in the midst of the mass finishing media. Such techniques are useful to impart a gloss to the final product. Such procedures are Rubbery materials or paint-based coatings also useful to remove statically bound particles on the product which become attached in earlier manufacturing steps. Grit-blasting procedures are another example of mass finishing techniques in which the present invention is useful. This rather aggressive finishing technique may result in considerable damage to either the textured surface or the maskant plate. Accordingly, a maskant plate possessing all of the virtues of the present invention is desirable. The invention is also useful to protect selected surfaces during any number of cleaning procedures. In the case of solution cleaning, the maskant plate will ideally prevent but at least minimize the contact of the cleaning solution with the surface to be protected.

Moreover, it is useful for the maskant plate to be capable of affording protection from laser light. Laser light is used in marking of the prosthetic devices in order to effect traceability. However, laser etching of the textured surface is expected to modify its morphology and adversely affect its resulting fixation stability. Red and infrared lasers are typically used for such applications, however, other wavelengths are also possible. The maskant plates of the present invention demonstrate excellent protection against inadvertent laser etching of textured surfaces.

It is oftentimes desirable to passivate selected surfaces of a prosthetic device. This is typically accomplished by dipping the prosthetic device in a solution of dilute nitric acid (HNO₃). This results in a uniform passive oxide layer in selected surfaces of the device. The maskant plates of the present invention afford good protection to various surfaces of the device for which contact with the passivation solution is not wanted.

In light of the detailed teachings above with regard to choice of maskant and the details of securing and positioning the particular maskant material, the general method of masking such a surface comprises securing and positioning a maskant plate on at least a part of the textured surface, performing post-oxidation mass finishing, and removing said maskant plate. These steps can be optionally repeated until the desired finish is obtained while protecting the textured surface. Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

References

All patents and publications mentioned in the specification are indicative of the level of those skilled in the art to which the invention pertains. All patents and publications are herein incorporated by reference to the same extent as if each individual publication was specifically and individually indicated to be incorporated by reference.

| | | |
|---|---|---|
| U.S. Pat. No. 4,612,737 | September 1986 | Adee |
| U.S. Pat. No. 4,325,779 | April 1982 | Rossetti |
| U.S. Pat. No. 3,948,829 | April 1976 | Babayan |
| U.S. Pat. No. 5,066,450 | November 1991 | Steinicke |
| U.S. Pat. No. 5,126,005 | June 1992 | Blake |
| U.S. Pat. No. 5,271,953 | December 1993 | Litteral |
| U.S. Pat. No. 5,240,746 | August 1993 | O' Connor Litteral |
| U.S. Pat. No. 2,987,352 | June 1961 | Watson |
| U.S. Pat. No. 4,671,824 | June 1987 | Haygarth |
| U.S. Pat. No. 5,037,438 | August 1991 | Davidson |
| U.S. Pat. No. 5,152,794 | October 1992 | Davidson |
| U.S. Pat. No. 5,180,394 | January 1993 | Davidson |
| U.S. Pat. No. 5,370,694 | December 1994 | Davidson |
| U.S. Pat. No. 5,372,660 | December 1994 | Davidson |
| U.S. Pat. No. 5,496,359 | March 1996 | Davidson |
| U.S. Pat. No. 5,549,667 | August 1996 | Davidson |
| U.S. Pat. No. 5,169,597 | December 1992 | Davidson |
| U.S. Pat. No. 6,193,762 | February 2001 | Wagner |
| U.S. Pat. No. 5,922,029 | July 1999 | Wagner |
| U.S. Pat. No. 5,258,098 | November 1993 | Wagner |
| U.S. Pat. No. 5,507,815 | April 1996 | Wagner |
| U.S. Pat. No. 4,272,855 | June 1981 | Frey |
| U.S. Pat. No. 4,673,409 | June 1987 | Van Kampen |
| U.S. Pat. No. 4,644,942 | February 1987 | Sump |
| U.S. Pat. No. 4,865,603 | September 1989 | Noiles |
| U.S. Pat. No. 5,240,746 | August 1993 | Litteral |

What is claimed is:

1. A method of masking a textured diffusion-hardened surface on a prosthetic device during post-oxidation mass finishing comprising the steps of:
positioning a plate on at least a part of the textured surface to be masked;
performing post-oxidation mass finishing; and,
removing said plate.

2. The method of claim 1 wherein said plate is a sheet metal plate.

3. The method of claim 1 wherein said plate is a stainless steel plate.

4. The method of claim 1 wherein said plate is a plastic plate.

5. The method of claim 4 wherein said plastic plate is a polyvinyl chloride plate.

6. The method of claim 1 further comprising repeating one or more times, said steps of positioning, performing, and removing.

7. The method of claim 1 wherein said textured diffusion-hardened surface comprises a composition selected from the group consisting of oxidized zirconium, oxidized hafnium, oxidized niobium, and oxidized titanium.

8. The method of claim 7 wherein said textured diffusion-hardened surface comprises oxidized zirconium.

9. The method of claim 1 wherein said surface is formed on a substrate comprising materials selected from the group consisting of zirconium, titanium, hafnium, niobium, and alloys thereof.

10. The method of claim 9 wherein said surface is formed on a substrate comprising zirconium or zirconium alloy.

11. The method of claim 10 wherein said substrate consists of an alloy composition of;
from about 10 to about 50 weight % niobium;
from about 13 to about 20 weight % zirconium; and,
the balance titanium.

12. The method of claim 11 wherein said substrate consists of an alloy composition of:
about 74 weight % titanium;
about 13 weight % niobium; and,
about 13 weight % zirconium.

13. The method of claim 1 wherein said step of positioning further comprises positioning with a mandrel.

14. The method of claim 1 wherein said step of positioning further comprises positioning using a locking ring or set screw or both.

15. The method of claim 1 wherein said step of positioning comprises positioning a plate which completely covers and extends past the textured surface to be masked.

16. The method of claim 15 wherein said step of positioning a plate which completely covers and extends past the textured surface to be masked comprises completely covering and extending past the textured surface by about 10% of the total length of the textured region.

17. The method of claim 1 wherein the step of performing post oxidation mass finishing comprises a tumbling procedure.

18. The method of claim 1 wherein the step of performing post oxidation mass finishing comprises a grit-blasting procedure.

19. The method of claim 1 wherein the step of performing post oxidation mass finishing comprises a cleaning procedure.

20. The method of claim 1 wherein the step of performing post oxidation mass finishing comprises the application of laser light to the prosthetic device.

21. The method of claim 20 wherein the application of laser light further comprises laser marking of the prosthetic device.

22. The method of claim 1 wherein the step of performing post oxidation mass finishing comprises a passivation step.

23. The method of claim 22 wherein the passivation step further comprises contacting the prosthetic device with a nitric acid solution.
